(19) United States
(12) Patent Application Publication
(10) Pub. No.: US 2011/0299442 A1
(43) Pub. Date: Dec. 8, 2011

(54) METHODS AND APPARATUS FOR CONTROLLING LOCATION FOR STARTING DECODING OF SUB-PACKETS OF A COMMUNICATION PACKET

(76) Inventors: Sairamesh Nammi, Dallas, TX (US); Narendra Tilwani, Addison, TX (US)

(21) Appl. No.: 12/961,077

(22) Filed: Dec. 6, 2010

Related U.S. Application Data
(60) Provisional application No. 61/351,448, filed on Jun. 4, 2010.

(51) Int. Cl. H04W 4/00; H04J 3/24

(52) U.S. Cl. 370/310; 370/474

(57) ABSTRACT

A communication device includes a decoder that sequentially decodes sub-packets of a first packet that contain redundant traffic information. The decoder identifies a first sequence location where it successfully decoded one of the sub-packets of the first packet to output the traffic information. The decoder then sequentially decodes sub-packets of a second packet starting at a second sequence location that is determined in response to the first sequence location. Related methods, user equipment node, and radio access network nodes are also disclosed.

### RELATED APPLICATIONS

The present application claims the benefit of priority from U.S. Provisional Application No. 61/351,448 entitled “Method And Apparatus For limiting the Decoding Attempts pr an Early Frame Termination System” filed Jun. 4, 2010, the disclosure of which is hereby incorporated herein in its entirety by reference.

### TECHNICAL FIELD

The present disclosure is directed to network communications and, more particularly, to decoding packets that are received at a communication device.

### BACKGROUND

In a typical cellular radio system, user equipment unit nodes (UEs) (also known as wireless terminals or mobile stations) communicate via a radio access network (RAN) with one or more core networks. The RAN covers a geographical area which is divided into cell areas, with each cell area being served by a radio node, e.g., a radio base station (BS), which in some networks is also called a “NodeB” or enhanced NodeB “eNodeB.” A cell area is a geographical area where radio coverage is provided by the base station equipment at a base station site. The base stations communicate through radio communication channels with UEs within range of the base stations.

A RAN node encodes traffic information (e.g., user voice/data) into a packet using a selected encoding algorithm and rate for transmission during a communication frame to a UE, and the UE correspondingly decodes the packets to output the traffic information. When a packet is encoded, the traffic information can be redundantly coded in a sequence of sub-packets of the packet. Depending upon channel conditions, it may be possible to successfully decode a packet to obtain the traffic information before reaching the last sub-packet in the sequence.

A proposal has been made to the Third Generation Partnership Project (3GPP) to allow early frame termination (EFT). When sub-packets are transmitted by a RAN during a sequence of Power Control Group (PCG) periods of a frame, a UE decodes each of the sub-packets as they are received until a sub-packet is successfully decoded to output traffic information. The UE may then transmit an early frame termination message to the RAN to stop further transmission of any remaining sub-packets of the packet.

It has been shown that system capacity may be improved by more than three times when RANs and UEs operate using early frame termination. However, early frame termination may significantly increase the processing demands on the UE due to its repetitively attempts to decode sub-packets instead of waiting for receipt of the entire packet. For example, when a frame is decoded successfully at the 12^{th} PCG period, the UE will have completed 11 unsuccessful decoding attempts before the successful 12th decoding attempt. Thus, according to this example, the processing demands that are imposed on the UE by early frame termination may be 12 times greater than for another UE that initiates decoding alter it has received an entire packet.

### SUMMARY

According to some embodiments of the present invention, a communication device includes a decoder that sequentially decodes sub-packets of a first packet that contain redundant traffic information. The decoder identifies a first sequence location where it has successfully decoded one of the sub-packets of the first packet to output the traffic information. The decoder then sequentially decodes sub-packets of a second packet starting at a second sequence location that is determined in response to the first sequence location.

In some further embodiments, the decoder responds to the successful decoding of one of the sub-packets of the first packet by triggering communication of a message to another communication device that is communicating the sub-packets to terminate communication of any remaining portion of the sequence of sub-packets of the first packet.

The second sequence location where the decoder starts decoding sub-packets of the second packet may be a defined number of sub-packet locations earlier than the first sequence location. The decoder may sequentially decode the sub-packets of each of the first and second packets starting no earlier than a default sequence location that is defined by a common coding rate of the sub-packets of the first and second packets. When the sub-packets of the second packet have a different coding rate than the sub-packets of the first packet, the decoder may respond by sequentially decoding the sub-packets of the second packet starting at the default sequence location.

In some further embodiments, the communication device includes a RF receiver that sequentially receives the sub-packets of the first packet during a sequence of Power Control Group (PCG) periods of a first frame and sequentially receives the sub-packets of the second packet during another corresponding sequence of PCG periods of a second frame. The decoder identifies a first number of the PCG periods of the first frame where one of the sub-packets successfully decoded to output the traffic information, and then sequentially decode the sub-packets of the second packet starting at a second number of the PCG periods of the second frame that is determined in response to the first number of the PCG periods of the first frame.

Some other embodiments are directed to a method that includes sequentially decoding sub-packets of a first packet that contain redundant traffic information. A first sequence location is identified where one of the sub-packets of the first packet successfully decoded to output the traffic information. Sub-packets of a second packet are sequentially decoded starting at a second sequence location that is determined in response to the first sequence location.

Some other embodiments are directed to a user equipment node that includes a RF receiver and a decoder. The RF receiver sequentially receives, from a radio access network node, sub-packets of a first packet during a first frame and sub-packets of a second packet during a second frame. The decoder sequentially decodes the sub-packets of the first packet and identifies a first sequence location where one of the sub-packets of the first packet successfully decoded to output traffic information. The decoder then sequentially decodes the sub-packets of the second packet starting at a second sequence location that is determined in response to the first sequence location.

Some other embodiments are directed to a radio access network node that includes a RF receiver and a decoder. The RF receiver sequentially receives, from a user equipment node, sub-packets of a first packet during a first frame and sub-packets of a second packet during a second frame. The decoder sequentially decodes the sub-packets of the first packet and identifies a first sequence location where one of the sub-packets of the first packet successfully decoded to output traffic information. The decoder then sequentially decodes the sub-packets of the second packet starting at a second sequence location that is determined in response to the first sequence location.

### BRIEF DESCRIPTION OF THE DRAWINGS

The accompanying drawings, which are included to provide a further understanding of the disclosure and are incorporated in and constitute a part of this application, illustrate certain non-limiting embodiment(s) of the invention. In the drawings:

FIG. 1 is a block diagram of a communication system that is configured according to some embodiments;

FIG. 2 illustrates a sequence of packets transported through a network communication link, such as a radio communication link, during a corresponding sequence of communication frames;

FIGS. 3-9 illustrate a sequence of packets and corresponding operations and methods for controlling a starting location for decoding sub-packets according to some embodiments;

FIG. 10 is a flowchart of operations and methods for communicating a sequence of sub-packets in a communication frame and for terminating communication of further sub-packets in the sequence according to some embodiments;

FIG. 11 is a flowchart of operations and methods for controlling a starting location for decoding sub-packets of a packet during a communication frame and for signaling early frame termination according to some embodiments;

FIG. 12 is a more general flowchart of operations and methods for controlling a starting location for decoding sub-packets of a packet during a communication frame according to some embodiments;

FIG. 13 is a block diagram of a user equipment node that is configured according to some embodiments; and

FIG. 14 is a block diagram of a radio access network node that is configured according to some embodiments.

### DETAILED DESCRIPTION

The invention will now be described more fully hereinafter with reference to the accompanying drawings, in which embodiments of the invention are shown. This invention may, however, be embodied in many different forms and should not be construed as limited to the embodiments set forth herein.

Various embodiments of the invention are directed to methods, communication devices, user equipment nodes, and radio access network nodes that decode sub-packets in various ways that may reduce the number of decoding attempts that are used to obtain traffic information being carried by a packet. The decoding can be carried out while keeping track of a location within a previous sequence of sub-packets where decoding successfully output traffic information from a previous packet. That location can be used to determine a location within the next sequence of sub-packets of a next packet where decoding is to be started. Accordingly, instead of attempting to decode a packet starting from its first sub-packet or otherwise starting from the same sub-packet location for each packet, the starting location for decoding can be controlled responsive to an earlier successful decoding location. In this manner, a location within a sequence of sub-packets where decoding is started can be controlled to reduce the number of decoding attempts and/or to better track the effect of dynamic changes that are occurring in a communication channel through which the sub-packets are being received.

When the decoding algorithm employed by the receiving device is computationally intensive, such as a convolutional-based decoding algorithm, reducing the number of decoding attempts can result in a substantial reduction in the processing requirements for the receiving device. By way of example, when a packet of a first frame is successfully decoded at a 12th sub-packet location, decoding of another packet of a second frame can be controlled to start at a sub-packet sequence location that is determined in response to the identified 12th sub-packet location. When the communication channel is static or slowly varying, decoding of the second frame packet may be controlled to start at the twelfth sub-packet location or another location that is close to the 12th sub-packet location (e.g. at the 11th sub-packet). In contrast, when the communication channel is rapidly varying (e.g., fast fading conditions) decoding of the second frame packet may be controlled to start at a more distant offset location relative to the 12th sub-packet location (e.g., at the 9th/10th sub-packet).

For purposes of illustration and explanation only, these and other embodiments of the present invention are described herein in the context of operating in a RAN that communicates over radio communication channels with UEs. It will be understood, however, that the present invention is not limited to such embodiments and may be embodied generally in any type of communication network, including landline (non-radio access) networks, such as local area networks and/or wide area packet switched networks (e.g., Internet). As used herein, a UE can include any device that decodes packetized data received over a wireless and/or wireline communication network to extract traffic information, and may include, but is not limited to, a mobile telephone (“cellular” telephone), laptop/portable computer, pocket computer, hand-held computer, and/or desktop computer.

In some embodiments of a RAN, several base stations can be connected (e.g., by landlines or radio channels) to a radio network controller (RNC). The radio network controller, also sometimes termed a base station controller (BSC), supervises and coordinates various activities of the plural base stations connected thereto. The radio network controllers are typically connected to one or more core networks.

The Universal Mobile Telecommunications System (UMTS) is a third generation mobile communication system, which evolved from the Global System for Mobile Communications (GSM), and is intended to provide improved mobile communication services based on Wideband Code Division Multiple Access (WCDMA) access technology. UTRAN, short for UMTS Terrestrial Radio Access Network, is a collective term for the Node B's and Radio Network Controllers which make up the UMTS radio access network. Thus, UTRAN is essentially a radio access network using wideband code division multiple access for UEs.

The Third Generation Partnership Project (3GPP) has undertaken to further evolve the UTRAN and GSM based radio access network technologies. In this regard, specifications for the Evolved Universal Terrestrial Radio Access Network (E-UTRAN) are ongoing within 3GPP. The Evolved Universal Terrestrial Radio Access Network (E-UTRAN) comprises the Long Term Evolution (LTE) and System Architecture Evolution (SAE).

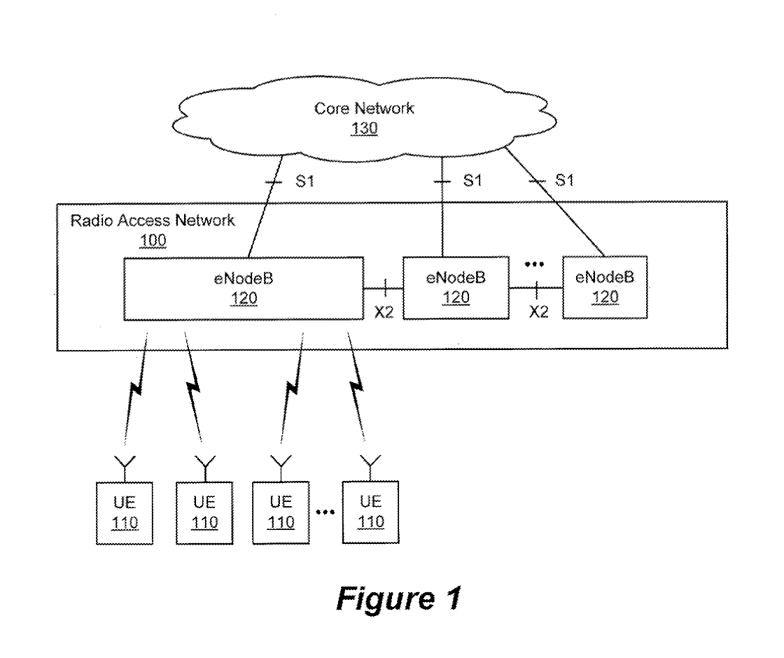

FIG. 1 is a block diagram of a communication system that is configured to operate according to some embodiments. An example RAN 100 is shown that may be a Long Term Evolution (LTE) RAN. The LTE RAN is a variant of a 3GPP RAN where radio base station nodes (eNodeBs) are connected directly to one or more core networks 130 rather than to radio network controller (RNC) nodes. In LTE, the functions of a radio network controller (RNC) node are performed by the radio base stations nodes 120. The radio base station nodes 120 communicate with user equipment nodes (UEs) 110 that are within their respective communication service cells. The radio base station nodes 120 can communicate with one another through an X2 interface and with the core network(s) 130 through SI interfaces, as is well known to one who is skilled in the art.

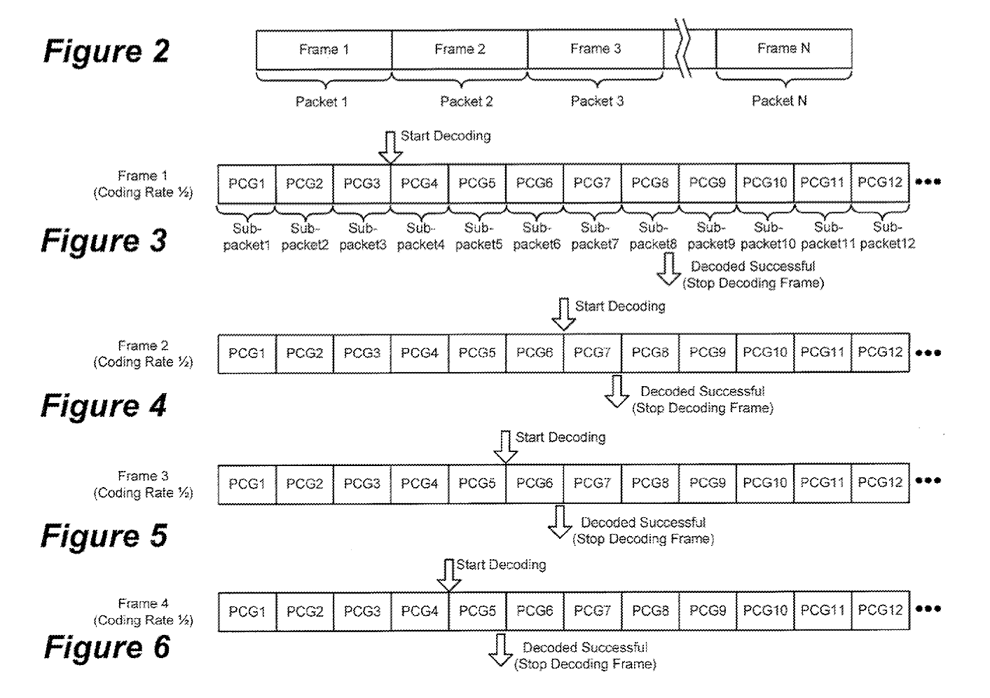

FIG. 2 illustrates a sequence of packets that may be transported through a data network from one communication device to another. In the context of the radio communication system of FIG. 1, each packet (e.g., Packets 1 . . . N) contains traffic information, such as voice and/or data, that is received from the core network(s) 130 for transmission from the RAN 100, via a defined radio base station node 120 during a corresponding communication frame (e.g., Frames 1 . . . N), to a defined UE 110. The packets may alternatively be communicated in the opposite direction from a UE 110 to a radio base station node 120.

The traffic information is encoded (e.g., by the radio base station node 120 or another network node of the RAN 100) across a plurality of sub-packets to generate the packet for transmission via a communication channel. For example, the radio base station node 120 may periodically/aperiodically receive and use a channel quality measurement (CQM) from one of the UEs 110 to select among available encoding algorithms (e.g., convolutional codes, turbo codes, low density parity check codes, etc.) and/or different code rates (e.g., 1 “full”, 1/2, 1/4, 1/8, etc.) for encoding the traffic information in a packet for transmission via a forward communication channel to the UE 110. The various different encoding algorithms and code rates may generate different levels of redundancy at which the traffic information is repeated across the sequence of sub-packets forming a packet.

In a similar manner, each UE 110 encodes traffic information across a plurality of sub-packets to generate a packet for transmission via a reverse communication channel to a radio base station node 120 providing service thereto. Each UE 110 may, responsive to a CQM or a command from a radio base station node 120, select among available encoding algorithms (e.g., convolutional codes, turbo codes, low density parity check codes, etc.) and/or different code rates (e.g., 1 “full”, 1/2, 1/4, 1/8, etc.) for encoding the traffic information in a packet for transmission to the UE 110. A full (“1”) coding rate generates sub-packets having a lowest level of traffic information redundancy encoded therein, and each of the 1/2, 1/4, 1/8 coding rates generate sub-packets having successively higher levels of traffic information redundancy encoded therein (i.e., 1/8 coding rate has the highest level of redundancy among the identified coding rates). The full coding rate may be selected when transmitting sub-packets through a high-quality channel and/or when the sub-packets contain low priority traffic information. In contrast, the 1/8 coding rate may be selected when transmitting sub-packets through a poor-quality channel and/or when the sub-packets contain high priority traffic information.

Each UE 110 and radio base station node 120 includes a decoder that is configured to sequentially decode sub-packets of a packet as they are received by the communication device. According to some embodiments, the decoder identifies a first sequence location where it successfully decoded one of the sub-packets of a present packet to output the traffic information. The decoder then sequentially decodes sub-packets of a next packet starting at a second sequence location that is determined in response to the first sequence location.

FIGS. 3-9 illustrate a sequence of packets and corresponding example operations and methods for controlling a starting location for decoding sub-packets.

For ease of explanation, a communication device that is receiving and decoding sub-packets is referred to herein as a “receiving device,” and the communication device that is encoding and transmitting sub-packets is referred to herein as a “transmitting device.” The communication device may, for example, be one of the UEs 110 and/or the radio base station nodes 120 shown in FIG. 1. FIG. 3 illustrates a sequence of sub-packets that form a packet (e.g., Packet 1) that are sequentially received by a receiving device during a corresponding sequence of a defined number of Power Control Group (PCG) periods of a frame (e.g., Frame 1). In the example of FIG. 3, the traffic information has been redundantly encoded across the sub-packets using a coding rate of 1/2. Each PCG period can correspond to an interval during which the transmitting device (e.g., the radio base station node 120) transmits symbols of a sub-packet at substantially the same power level. The power level at which the device transmits symbols can vary from one PCG period to another responsive to, for example, changing channel conditions. The number of PCG periods that form a frame may can be defined by a communication protocol used to communicate between the transmitting and receiving devices. For example, WCMDA defines 16 PCGs per frame.

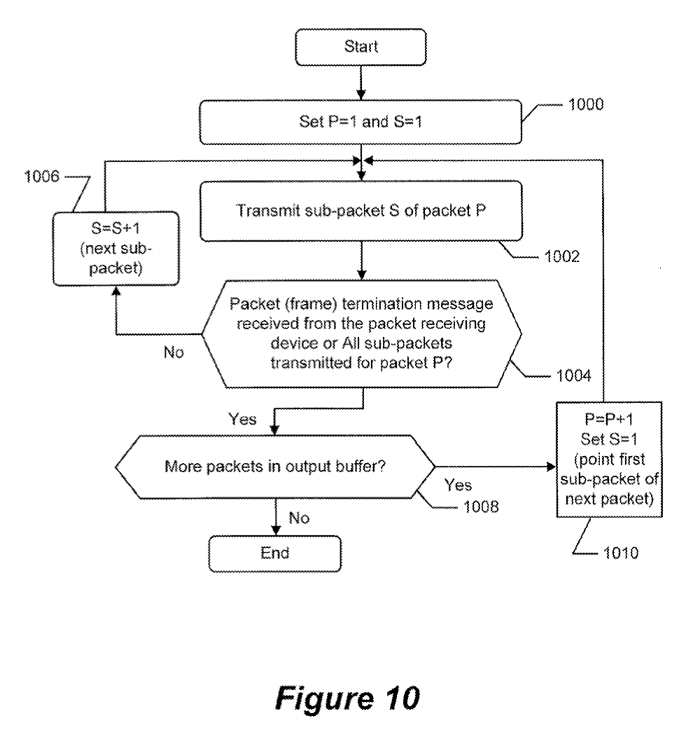

FIG. 10 is a flowchart of example operations and methods for communicating a sequence of sub-packets in a communication frame and for terminating further sub-packet communication. Referring to FIGS. 3 and 10, the transmitting device initializes (block 1000) a packet counter “P” and sub-packet counter “S” to default values (e.g., 1). The transmitting device then sequentially transmits (block 1002) symbols of packet number “S” of packet number “P” to the receiving device. As explained above, the transmitting device may also select (block 1002) among available encoding algorithms (e.g., convolutional codes, turbo codes, low density parity check codes, etc.) and/or different code rates (e.g., 1 “full”, 1/2, 1/4, 1/8, etc.) for redundantly encoding the traffic information across the sub-packets for transmission to the UE 110 during PCGs. After transmitting the sub-packet, the transmitting device determines (block 1004) whether a packet (frame) termination message has been received from the receiving device or whether all sub-packets for packet number P have been transmitted. If not, the sub-packet counter “S” is incremented (block 1006) to point to the next sub-packet, which is transmitted (block 1002) to the receiving device. Accordingly, as shown in FIG. 3, a sequence of sub-packets is transmitted from the transmitting device to the receiving device.

When a packet (frame) termination message has been received from the receiving device or all sub-packets for packet number P have been transmitted (block 1004), a further determination is made as to whether any other packets are in an output buffer awaiting transmission to the receiving device and, if so, the packet counter “P” is incremented (block 1010) to point to the next packet. The transmitting device then begins transmitting (block 1002) a first sub-packet of the next packet to the receiving device.

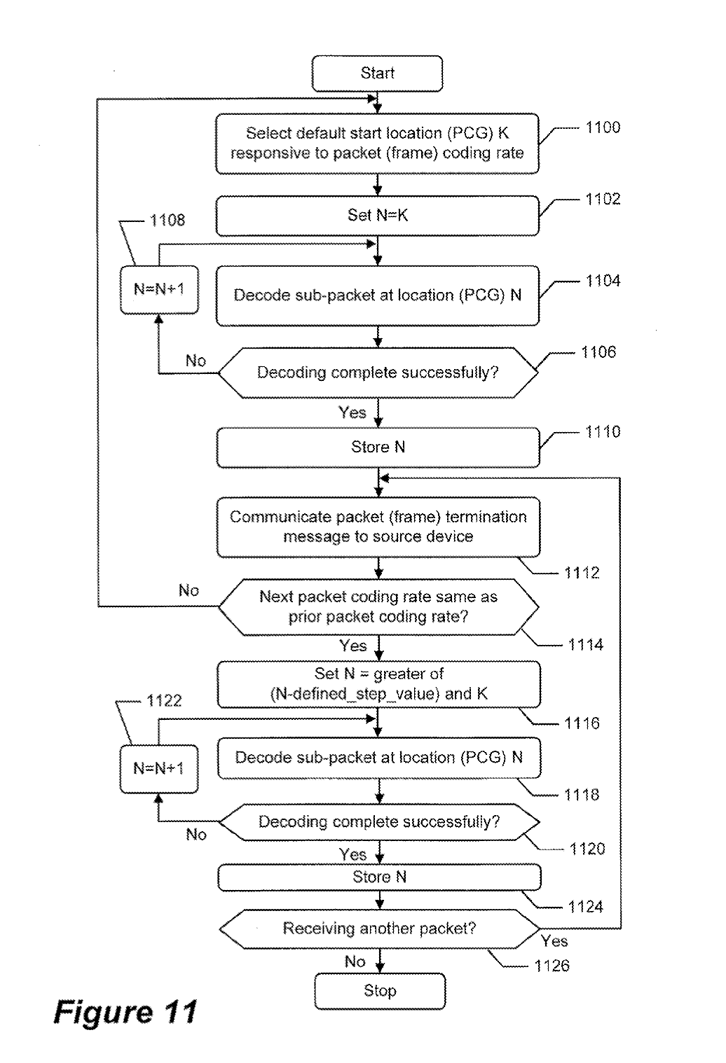

FIG. 11 is a flowchart of example operations and methods for controlling a starting location for decoding sub-packets of a packet during a communication frame and for signaling early frame termination. Referring now to FIGS. 3 and 11, the receiving device selects (block 1100) a default PCG number K where it will begin sequentially decoding sub-packets as they are received. The receiving device may select the default PCG number K in response to a coding rate of the sub-packets that are being received. The default PCG number K may, for example, be selected as PCG number 8 responsive to a coding rate of 1 “full”, selected as PCG number 4 responsive to a coding rate of 1/2, selected as PCG number 2 responsive to a coding rate of 1/4, and selected as PCG number 1 responsive to a coding rate of 1/8. Each of these default PCG numbers has been identified as an earliest location in a sequence of sub-packets for a packet where one of the sub-packets is likely to be able to be successful decoded when the packet is coded using one of the corresponding identified rates.

The receiving device sets (block 1102) a sub-packet counter “N” equal to the default PCG number K, and starts to decode (block 1104) sub-packet “N” in the sequence (i.e., the default PCG number K). As shown in FIG. 3, because the coding rate of the sub-packets is 1/2, the receiving device starts decoding at sub-packet number 4 received during PCG number 4. A determination is made (block 1106) whether the sub-packet successfully decoded to output the traffic information and, if not, the sub-packet counter “N” is incremented (block 1108) to point to the next sub-packet. For the example of FIG. 3, the operations of blocks 1104 through 1108 are repeated to sequentially decode sub-packet numbers 5, 6, 7, and 8 (received during PCG numbers 5, 6, 7, and 8) until sub-packet 8 is successfully decoded to output the traffic information. Decoding of any subsequent sub-packets of the present packet (i.e., Packet 1 during Frame 1) is then stopped (block 1106).

The receiving device stores (block 1110) the sub-packet counter “N” for use in determining a starting location for decoding sub-packets of the next packet. The receiving device communicates (block 1112) a packet (frame) termination message to the transmitting device to cause the transmitting device to stop transmitting any remaining sub-packets (i.e., sub-packet numbers 9, 10, etc.) of the present packet (i.e., Packet 1 during Frame 1).

In response to receiving a next packet (e.g., Packet 2 during Frame 2), the receiving device determines (block 1114) whether the present packet has the same coding rate as the prior packet (e.g., Packet 1). When the coding rate is different, the receiving device selects (block 1100), based on the coding rate of the present packet, a new default start location (default PCG number K) Where it will begin sequentially decoding sub-packets of the present packet. In contrast, when the present packet has the same coding rate as the prior packet, the receiving device selects (block 1116) a new starting location for decoding sub-packets beginning with a PCG number N that is the greater value of: 1) the previous PCG number N where a sub-packet of the prior packet was successfully decoded minus a defined step value offset; and 2) the default PCG number K. Accordingly, decoding is started at a PCG number that is determined based on the PCG number N where a sub-packet of the prior packet was successfully decoded.

In some embodiments the defined step value offset may be 1, to cause decoding to start one PCG number earlier, or may any other value to cause decoding to start at the same PCG number, an earlier number of PCGs, or a later number of PCGs relative to the PCG number of the prior frame where a sub-packet of the prior packet was successfully decoded. In some embodiments, the defined step value may be varied responsive to the sensed channel conditions or responsive to other defined criteria. For example, the defined step value may be held constant while the channel conditions remain substantially constant, and may be varied to track variation in the channel condition over which the sub-packets are being received.

The receiving device decodes (block 1118) the sub-packet at PCG number N. A determination is made (block 1120) whether the sub-packet successfully decoded to output the traffic information and, if not, the sub-packet counter N is incremented (block 1122) to point to the next sub-packet. That sub-packet is then decoded (block 1118). When decoding has completed successfully (block 1120), the receiving device stores (block 1124) the sub-packet counter “N” for use in determining a starting location for decoding sub-packets of the next packet (e.g., Packet 3 of Frame 3). A determination (block 1126) is made as to whether another packet is being received and, if so, the operational flow branches back to block 1112 to communicate a packet (frame) termination message to the transmitting device and to begin decoding the next packet.

In FIG. 4, the receiving device starts decoding (block 1118) Packet 2 during Frame 2 starting with sub-packet number 7 of PCG number 7, which is 1 PCG number earlier than PCG number 8 where decoding completed successfully during Frame 1 and which is not less than the default PCG number 3 for the 1/2 coding rate. Sub-packet 7 is successfully decoded, so the receiving device stops decoding (block 1120), stores PCG number 7 as the starting location N (block 1124), and transmits (block 1112) a frame termination message to the transmitting device.

In FIG. 5, the receiving device starts decoding (block 1118) Packet 3 during Frame 3 starting with sub-packet number 6 of PCG number 6, which is 1 PCG number earlier than PCG number 7 where decoding completed successfully during Frame 2 and which is not less than the default PCG number 3 for the 1/2 coding rate. Sub-packet 6 is successfully decoded, so the receiving device stops decoding (block 1120), stores PCG number 6 as the starting location N (block 1124), and transmits (block 1112) a frame termination message to the transmitting device.

In FIG. 6, the receiving device starts decoding (block 1118) Packet 4 during Frame 4 starting with sub-packet number 5 of PCG number 5, which is 1 PCG number earlier than PCG number 6 where decoding completed successfully during Frame 2 and which is not less than the default PCG number 3 for the 1/2 coding rate. Sub-packet 5 is successfully decoded, so the receiving device stops decoding (block 1120), stores PCG number 5 as the starting location N (block 1124), and transmits (block 1112) a frame termination message to the transmitting device.

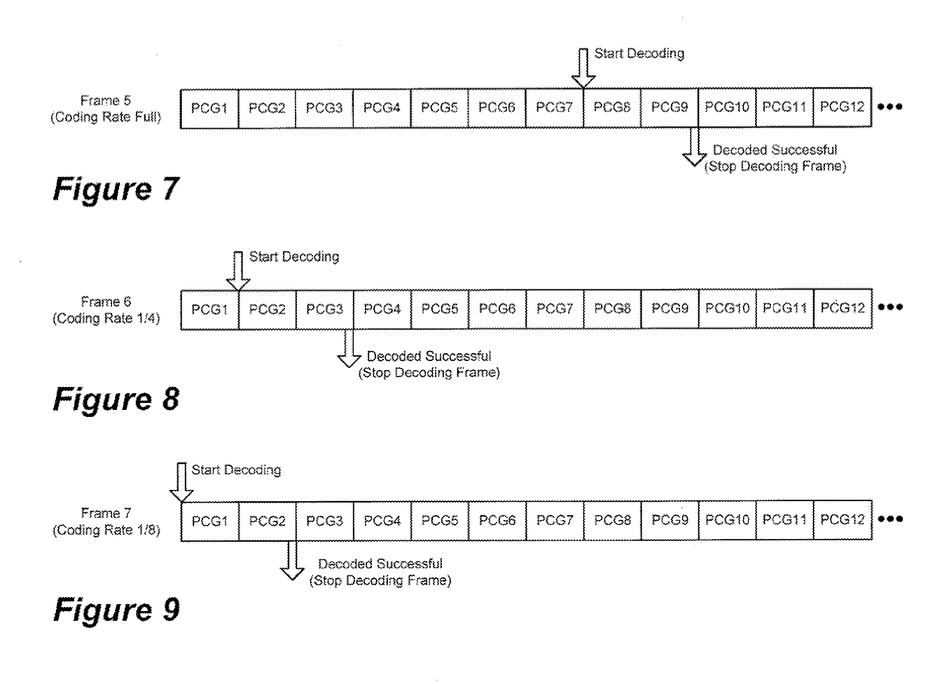

In FIG. 7, the transmitting device has changed the coding rate to a full (“1”) rate. Consequently, the receiving device starts decoding (block 1118) Packet 5 during Frame 5 starting with sub-packet number 8 of PCG number 8 (which is the example default PCG number for full coding rate). Sub-packet is not successfully decoded, so the receiving device then decodes sub-packet number 9 of PCG number 9. Sub-packet 9 is successfully decoded, so the receiving device stops decoding (block 1120), stores PCG number 9 as the starting location N (block 1124), and transmits (block 1112) a frame termination message to the transmitting device.

In FIG. 8, the transmitting device has changed the coding rate to a 1/4 rate. Consequently, the receiving device starts decoding (block 1118) Packet 6 during Frame 6 starting with sub-packet number 2 of PCG number 2 (which is the example default PCG number for a 1/4 coding rate). Sub-packet 2 is not successfully decoded, so the receiving device then decodes sub-packet 3 of PCG number 3. Sub-packet 3 is successfully decoded, so the receiving device stops decoding (block 1120), stores PCG number 3 as the starting location N (block 1124), and transmits (block 1112) a frame termination message to the transmitting device.

In FIG. 9, the transmitting device has changed the coding rate to a 1/8 rate. Consequently, the receiving device starts decoding (block 1118) Packet 7 during Frame 7 starting with sub-packet number 1 of PCG number 1 (which is the example default PCG number for a 1/8 coding rate). Sub-packet is not successfully decoded, so the receiving device then decodes sub-packet 2 of PCG number 2. Sub-packet 2 is successfully decoded, so the receiving device stops decoding (block 1120), stores PCG number 2 as the starting location N (block 1124), and transmits (block 1112) a frame termination message to the transmitting device.

Accordingly, as explained above, instead of attempting to decode a packet starting from its first sub-packet or otherwise starting from the same sub-packet location for all packets, the starting location for decoding is controlled responsive to where decoding was successfully completed within the sub-packet sequence of a previous packet. In this manner, a location within a sequence of sub-packets where decoding is started can be controlled to reduce the number of decoding attempts and/or to better track the effect of dynamic changes that are occurring in a communication channel through which the sub-packets are being received.

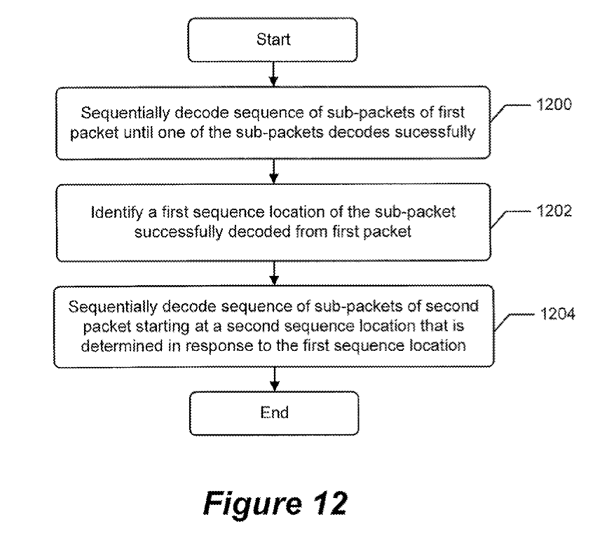

The operations and methods for controlling a starting location for decoding sub-packets of a packet during a communication frame are illustrated more generally in the flowchart of FIG. 12. Referring to FIG. 12, sub-packets of a first packet that contain redundant traffic information are sequentially decoded (block 1200) until one of the sub-packets decodes successfully. A first sequence location is identified (block 1202) where one of the sub-packets of the first packet successfully decoded to output the traffic information. Sub-packets of a second packet are sequentially decoded (block 1204) starting at a second sequence location that is determined in response to the first sequence location.

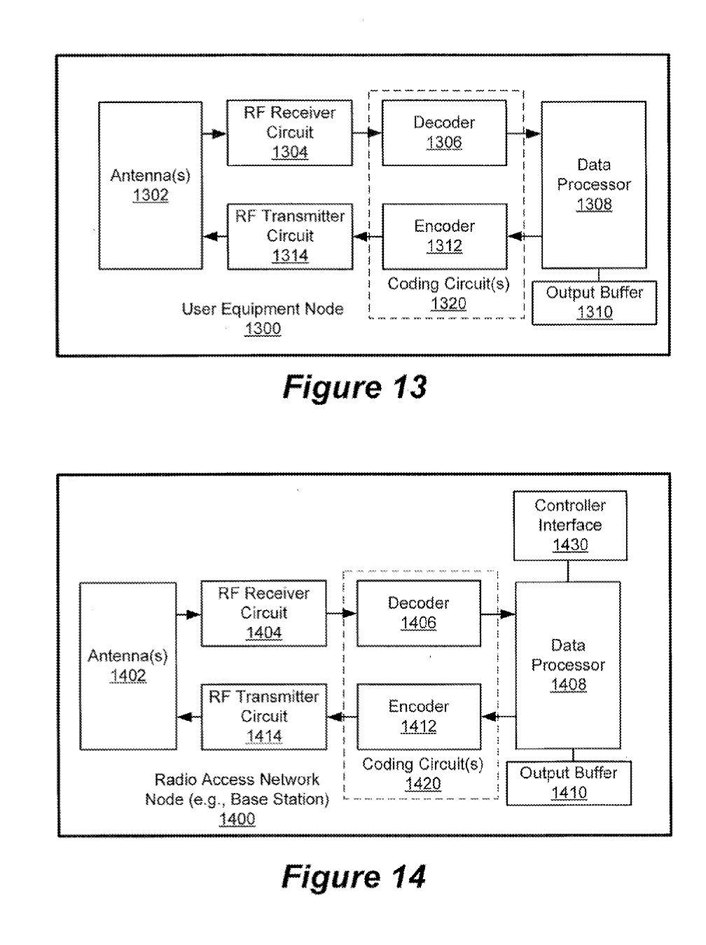

FIG. 13 is a block diagram of a user equipment node (UE) 1300 that is configured according to some embodiments. The user equipment node 1300 which may used as one or more of the UEs 110 of FIG. 1. The user equipment node 1300 includes one or more antennas 1302, a RF receiver circuit 1304, a coding circuit 1320, a data processor 1308, an output buffer 1310, and a RF transmitter circuit 1314. The coding circuit 1320 includes a decoder 1306 that decodes sub-packets that are received from another communication device (e.g., a radio access network node) via the antenna 1302 and RF receiver circuit 1304 to extract traffic information being transported by a packet. The coding circuit 1320 also includes an encoder 1312 that encodes traffic information in the output buffer 1310 across sub-packets of a packet for transmission to another communication device (e.g., a radio access network node) via the RF transmitter circuit 1314 and the antenna 1302. The data processor 1308 may be configured to use the received traffic information to carry out various functionality of the user equipment node 1300. The coding circuit 1320 and the data processor 1308 may include one or more data processing circuits, such as a general purpose and/or special purpose processor (e.g., microprocessor and/or digital signal processor) with on-board and/or separate memory device(s). The coding circuit 1320 is configured to execute computer program instructions from a memory device, described below as a computer readable medium, to perform at least some of the operations and methods of FIGS. 1-12. For example, the encoder 1312 may be configured to perform at least some or all of the operations and methods of FIG. 10, and the decoder 1306 may be configured to perform at least some or all of the operations and methods of FIGS. 11 and/or 12.

FIG. 14 is a block diagram of a radio access network node 1400 that is configured according to some embodiments. The radio access network node 1400 which may used as one or more of the eNodeBs 120 of FIG. 1. The radio access network node 1400 includes one or more antennas 1402, a RF receiver circuit 1404, a coding circuit 1420, a data processor 1408, an output buffer 1410, a RF transmitter circuit 1414, and a controller interface 1430. The coding circuit 1420 includes a decoder 1406 that decodes sub-packets that are received from another communication device (e.g., a user equipment node) via the antenna 1402 and RF receiver circuit 1404 to extract traffic information being transported by a packet. The controller interface 1430 may communicate the decoded traffic information to a core network. The coding circuit 1420 also includes an encoder 1412 that encodes traffic information in the output buffer 1410 across sub-packets of a packet for transmission to another communication device (e.g., a radio access network node) via the RF transmitter circuit 1414 and the antenna 1402. The controller interface 1430 may temporarily store traffic information from a core network in the output buffer 1410 awaiting communication to another device. The data processor 1308 may be configured to use the received traffic information to carry out various functionality of the radio access network node 1400. The coding circuit 1420 and the data processor 1408 may include one or more data processing circuits, such as a general purpose and/or special purpose processor (e.g., microprocessor and/or digital signal processor) with on-board and/or separate memory device(s). The coding circuit 1420 is configured to execute computer program instructions from a memory device, described below as a computer readable medium, to perform at least some of the operations and methods of FIGS. 1-12. For example, the encoder 1412 may be configured to perform at least some or all of the operations and methods of FIG. 10, and the decoder 1406 may be configured to perform at least some or all of the operations and methods of FIGS. 11 and/or 12.

In the above-description of various embodiments of the present invention, it is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks.

A tangible, non-transitory computer-readable medium may include an electronic, magnetic, optical, electromagnetic, or semiconductor data storage system, apparatus, or device. More specific examples of the computer-readable medium would include the following: a portable computer diskette, a random access memory (RAM) circuit, a read-only memory (ROM) circuit, an erasable programmable read-only memory (EPROM or Flash memory) circuit, a portable compact disc read-only memory (CD-ROM), and a portable digital video disc read-only memory (DVD/BlueRay).

The computer program instructions may also be loaded onto a computer and/or other programmable data processing apparatus to cause a series of operational steps to be performed on the computer and/or other programmable apparatus to produce a computer-implemented process such that the instructions which execute on the computer or other programmable apparatus provide steps for implementing the functions/acts specified in the block diagrams and/or flowchart block or blocks. Accordingly, embodiments of the present invention may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated. Moreover, although some of the diagrams include arrows on communication paths to show a primary direction of communication, it is to be understood that communication may occur in the opposite direction to the depicted arrows.

Many different embodiments have been disclosed herein, in connection with the above description and the drawings. It will be understood that it would be unduly repetitious and obfuscating to literally describe and illustrate every combination and subcombination of these embodiments. Accordingly, the present specification, including the drawings, shall be construed to constitute a complete written description of various example combinations and subcombinations of embodiments and of the manner and process of making and using them, and shall support claims to any such combination or subcombination.

Many variations and modifications can be made to the embodiments without substantially departing from the principles of the present invention. All such variations and modifications are intended to be included herein within the scope of the present invention.

What is claimed is:

1. A communication device comprising:
a decoder configured to sequentially decode sub-packets of a first packet that contain redundant traffic information, to identify a first sequence location where one of the sub-packets of the first packet successfully decoded to output the traffic information, and to sequentially decode sub-packets of a second packet starting at a second sequence location that is determined in response to the first sequence location.

2. The communication device of claim 1, wherein:
the decoder sequentially receives the sub-packets of the first packet from another communication device, and is further configured to respond to the successful decoding of one of the sub-packets of the first packet by triggering communication of a message to the other communication device to terminate communication of any remaining portion of the sequence of sub-packets of the first packet.

3. The communication device of claim 1, wherein:
the decoder is further configured to respond to the sub-packets of the second packet having a same coding rate as the sub-packets of the first packet by sequentially decoding the sub-packets of the second packet starting at the second sequence location which is a defined number of sub-packets offset from the first sequence location.

4. The communication device of claim 3, wherein:
the decoder is further configured to sequentially decode the sub-packets of each of the first and second packets starting no earlier than a default sequence location that is defined by a common coding rate of the sub-packets of the first and second packets.

5. The communication device of claim 4, wherein:
the decoder is further configured to respond to the sub-packets of the second packet having a different coding rate than the sub-packets of the first packet by sequentially decoding the sub-packets of the second packet starting at the default sequence location.

6. The communication device of claim 3, wherein:
following successful decoding of a sub-packet of each of the first and second packets, the decoder is further configured to respond to a sequence of sub-packets of a third packet having a same coding rate as the sub-packets of the first and second packets by sequentially decoding the sub-packets of the third packet starting a defined number of sub-packets offset from the second sequence location in the sub-packets of the second packet.

7. The communication device of claim 1, further comprising:
a Radio Frequency, RF, receiver that is configured to sequentially receive the sub-packets of the first packet during a sequence of Power Control Group, PCG, periods of a first frame and to sequentially receive the sub-packets of the second packet during another corresponding sequence of PCG periods of a second frame; and
the decoder is further configured to identify a first number of the PCG periods of the first frame where one of the sub-packets successfully decoded to output the traffic information, and to sequentially decode the sub-packets of the second packet starting at a second number of the PCG periods of the second frame that is determined in response to the first number of the PCG periods of the first frame.

8. The communication device of claim 7, wherein:
the decoder is further configured to respond to the sub-packets of the second packet having a same coding rate as the sub-packets of the first packet by sequentially decoding the sub-packets of the second packet starting a defined number of the PCG periods earlier in the second frame than the first number of the PCG periods of the first frame.

9. The communication device of claim 7, wherein:
the decoder is further configured to decode the sub-packets of the second packet starting no earlier than a default number of the PCG periods of the second frame that is defined by a coding rate of the sub-packets of the second packet.

10. The communication device of claim 9, wherein:
the decoder is further configured to respond to the sub-packets of the second packet having a coding rate of one, one-half, one-quarter, or one-eighth by defining the default number of the PCG periods of the second frame to be eight, four, two, or one, respectively.

11. The communication device of claim 9, wherein:
the decoder is further configured to respond to the sub-packets of the second packet having a different coding rate than the sub-packets of the first packet by sequentially decoding the sub-packets of the second packet starting at the default number of the PCG periods of the second frame.

12. The communication device of claim 7, wherein:
the RF receiver is configured to receive the first and second packets from a radio access network node and to transmit a power control signal to the radio access network node during each of the PCG periods; and
the decoder is further configured to respond to successful decoding of one of the sub-packets of the first packet by triggering communication of a frame termination message to the radio access network node to terminate transmission of any remaining portion of the sequence of sub-packets of the first packet, and to respond to successful decoding of one of the sub-packets of the second packet by triggering communication of another frame termination message to the radio access network node to terminate transmission of any remaining portion of the sequence of sub-packets of the second packet.

13. The communication device of claim 7, wherein:
the RF receiver is configured to receive the first and second packets from a user equipment node; and
the decoder is further configured to respond to successful decoding of one of the sub-packets of the first packet by triggering communication of a frame termination message to the user equipment node to terminate transmission of any remaining portion of the sequence of sub-packets of the first packet, and to respond to successful decoding of one of the sub-packets of the second packet by triggering communication of another frame termination message to the user equipment node to terminate transmission of any remaining portion of the sequence of sub-packets of the second packet.

14. A method comprising:
sequentially decoding sub-packets of a first packet that contain redundant traffic information;
identifying a first sequence location where one of the sub-packets of the first packet successfully decoded to output the traffic information; and
sequentially decoding sub-packets of a second packet starting at a second sequence location that is determined in response to the first sequence location.

15. The method of claim 14, further comprising:
sequentially receiving the sub-packets of the first packet from another communication device; and
responsive to the successful decoding of one of the sub-packets of the first packet, communicating a message to the other communication device to terminate communication of any remaining portion of the sequence of sub-packets of the first packet.

16. The method of claim 14, further comprising:
responsive to the sub-packets of the second packet having a same coding rate as the sub-packets of the first packet, sequentially decoding the sub-packets of the second packet starting at the second sequence location which is a defined number of sub-packets offset from the first sequence location.

17. The method of claim 16, further comprising:
sequentially decoding the sub-packets of the second packet starting no earlier than a default sequence location that is defined by a coding rate of the sub-packets of the second packet.

18. The method of claim 17, further comprising:
responsive to the sub-packets of the second packet having a different coding rate than the sub-packets of the first packet, sequentially decoding the sub-packets of the second packet starting at the default sequence location.

19. The method of claim 14, further comprising:
sequentially receiving the sub-packets of the first packet during a sequence of Power Control Group, PCG, periods of a first frame;
identifying a first number of the PCG periods of the first frame where one of the sub-packets successfully decoded to output the traffic information;
sequentially receiving the sub-packets of the second packet during a sequence of PCG periods of a second frame; and
sequentially decoding the sub-packets of the second packet starting at a second number of the PCG periods of the second frame that is determined in response to the first number of the PCG periods of the first frame.

20. The method of claim 19, wherein:
responsive to the sub-packets of the second packet having a same coding rate as the sub-packets of the first packet, sequentially decoding the sub-packets of the second packet starting at the second number of PCG periods of the second frame; and
responsive to the sub-packets of the second packet having a different coding rate than the sub-packets of the first packet, sequentially decoding the sub-packets of the second packet starting at a default number of PCG periods of the second frame that is defined by a coding rate of the sub-packets of the second packet.

21. A user equipment node comprising:
a RF receiver configured to sequentially receive from a radio access network node sub-packets of a first packet during a first frame and sub-packets of a second packet during a second frame; and
a decoder configured to sequentially decode the sub-packets of the first packet, to identify a first sequence location where one of the sub-packets of the first packet successfully decoded to output traffic information, and to sequentially decode the sub-packets of the second packet starting at a second sequence location that is determined in response to the first sequence location.

22. The user equipment node of claim 21, wherein:
the decoder is further configured to respond to successful decoding of one of the sub-packets of the first packet by triggering communication of a frame termination message to the radio access network node to terminate transmission of any remaining portion of the sequence of sub-packets of the first packet.

23. The user equipment node of claim 21, wherein:
the decoder is further configured to respond to the sub-packets of the second packet having a different coding rate than the sub-packets of the first packet by sequentially decoding the sub-packets of the second packet starting at a default sequence location that is defined by a coding rate of the sub-packets of the second packet.

24. A radio access network node comprising:
a RF receiver configured to sequentially receive from a user equipment node sub-packets of a first packet during a first frame and sub-packets of a second packet during a second frame; and
a decoder configured to sequentially decode the sub-packets of the first packet, to identify a first sequence location where one of the sub-packets of the first packet successfully decoded to output traffic information, and to sequentially decode the sub-packets of the second packet starting at a second sequence location that is determined in response to the first sequence location.

25. The radio access network node of claim 24, wherein:
the decoder is further configured to respond to the sub-packets of the second packet having a different coding rate than the sub-packets of the first packet by sequentially decoding the sub-packets of the second packet starting at a default sequence location that is defined by a coding rate of the sub-packets of the second packet.
